(19) United States
(12) Patent Application Publication
(10) Pub. No.: US 2023/0281687 A1
(43) Pub. Date: Sep. 7, 2023

(54) REAL-TIME FRAUD DETECTION BASED ON DEVICE FINGERPRINTING

(71) Applicant: OLX Global B.V., Hoofddorp (NL)

(72) Inventors: Bhagirath Bhardwaj, Gurugram (IN); Tanweer Alam, Gurgaon (IN); Aditya Gupta, Gurgaon (IN); Hitesh Kumar, Gurugram (IN); Ankit Aggarwal, Delhi (IN); Varun Mittal, Rajasthan (IN); Lokesh Bhatt, Rajasthan (IN); Harshit Trivedi, Uttar Pradesh (IN)

(21) Appl. No.: 17/683,486

(22) Filed: Mar. 1, 2022

(51) Int. Cl. G06Q 30/06; G06Q 20/40; G06N 20/00

(52) U.S. Cl. CPC G06Q 30/0609; G06N 20/00; G06Q 20/4014; G06Q 20/4016; G06Q 30/0603

(57) ABSTRACT

Provided are systems and methods for real-time identification of fraudulent users of an online resource such as a website or mobile application, including new user accounts that have yet to transact on the online resource. In one example, a method may include receiving, by a host platform of an online resource, a request from a user device associated with a user account of the online resource, creating, by the host platform, a device fingerprint of the user device based on a plurality of device attributes included in the request, determining, by the host platform, whether the device fingerprint matches a previously banned device fingerprint stored in a database by the online resource, and in response to a determination that the device fingerprint has been banned previously, automatically restricting, by the host platform, an ability of the user account with the online resource.

### BACKGROUND

An online marketplace enables buyers to purchase items from sellers through a website, a mobile application, a third party, or the like. Given the lack of face-to-face interaction and the relative anonymity of both the buyer and the seller, these online marketplaces can be a breeding ground for fraudulent activity. A common form of fraud is to clone or take-over a genuine seller’s account with fake details and use it to trick legitimate buyers into buying something they will never receive. For example, a fraudster may post an expensive item at a significantly discounted price thereby luring victims. Through this scenario, the fraudster may lure the victim to a different website to steal credit card details and other personal information that the customer submits for payment. In another common form of fraud, a fraudster may create multiple fake buyer and seller accounts. The fake buyers then pay fake sellers for non-existent goods or services using stolen credit card numbers. These stolen identities are used to launder money online under the guise of online purchases until the fraud is detected and the cards are blocked.

There has been a large effort to combat marketplace fraud. However, these efforts are primarily “reactive” in nature. In other words, they are formulated after the fraud has been detected thereby giving fraudsters a significant head-start on their scams. In the online marketplace, speed for fraud detection is critical. Detecting the fraud in a relevant amount of time can be difficult. For example, customers often require overnight or two-day shipping. This requires that the fraud be identified before the goods are shipped, otherwise the opportunity is lost. Accordingly, a proactive system for counteracting online marketplace fraud is needed.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a computing environment of an online marketplace for fraud detection in accordance with an example embodiment.

FIG. 2A is a diagram illustrating a process of identifying fraudulent users based on machine learning in accordance with example embodiments.

FIG. 2B is a diagram illustrating a process of auto-banning a new user account based on device fingerprinting in accordance with example embodiments.

FIG. 2C is a diagram illustrating a process of creating a device fingerprint in accordance with an example embodiment.

FIGS. 3A-3C are diagrams illustrating a proactive banning process based on a graph database in accordance with example embodiments.

FIG. 4 is a diagram illustrating a method of automatically banning a new user account in accordance with example embodiments.

FIG. 5 is a diagram illustrating a computing system for performing the methods and processes of the example embodiments.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments that is shown but is to be accorded the widest scope consistent with the principles and features disclosed herein.

As the Internet continues to evolve, the selling of first and second-hand goods via commerce-based websites and mobile applications has become an increasingly popular activity. Users and/or businesses located at different geographical places may interact with each other through a common online marketplace such as a website or mobile application where sellers place their items for sale. Interested users (i.e., potential buyers) can chat, email, or even leave voice notes for sellers soliciting bids, barters, questions, posting reviews, and the like. Users can access the marketplace using mobile devices such as Android and iOS-based devices as well as using a web browser such as when accessing a progressive web application (PWA), website, or the like.

However, online marketplaces are often targets for fraud. For example, fraudsters may employ fake accounts in which fraudulent seller accounts may be created in bulk or account takeover where fraudsters take over seller accounts and use them to sell fictitious items. As another example, fake seller fraud occurs when fraudsters copy profiles of genuine sellers and use them to con customers. As another example, clone fraud refers to fraudsters copying genuine posts from a seller and posting it either on the same platform or other marketplace or social media to double sell. As yet another example, a group of users could be working in tandem. In general, distinguishing genuine sellers from fictitious or fraudulent sellers can be difficult. Furthermore, any delay in the buying/selling process to a genuine user may cause that user to go elsewhere.

Fraud may be detected using transaction data (e.g., content posted on a page of an application or a website) and/or user behavior data (e.g., clickstream data, etc.) For example, machine learning can be used to process the content and correlate the content with patterns of fraud. When a fraudulent user account is detected, the online marketplace may take steps to “ban” the fraudulent user account, for example, by disabling the user account, prevent it or otherwise restricting the ability of the fraudulent user account to transact within the online marketplace, sending a warning to other uses, and the like. However, at present, there is very little to prevent the fraudster from simply creating a new user account to continue to conduct fraud on the online marketplace.

The example embodiments are directed to a system which can combat the issue of online marketplace fraud in real-time, even detecting new users who have yet to transact within the online marketplace. In particular, the system may use the technique of device fingerprinting to identify a device regardless of the user account. Thus, the device itself can be identified for fraud even when the user account changes. The host platform may include a back-end system for hosting the online marketplace. Here, the clients that transact on the online marketplace may be require to connect to the online marketplace via an application programming interface (API) of the host platform / online marketplace. The API may ensure that each request from a client device include data from the client device which can be used by the backend system to create a device fingerprint. For example, the host platform may create the device fingerprint based on a combination of attributes from the device such as, for example, screen size, browser characteristics, cookies, HTTP header data, browser plug-ins that have been installed, screen size, color, resolution, time zone, system fonts, etc.

By creating a unique identifier of a client device based on device characteristics, the host platform is able to detect a fraudulent user even when the fraudulent user is using a new account with no transaction history. Furthermore, each device fingerprint may be stored as its own node in a graph database. Furthermore, a user account may be stored as a separate node in the graph database. When a fraudulent user is detected, both the user account and the device fingerprint may be “banned” in response. The banned user account and the banned device fingerprint may be stored in the graph database and used for real-time banning and proactive banning.

When a user creates a new account and sends a request to the host platform, for example, to transact within the online marketplace, the host platform may create a device fingerprint of a user device of the new user account based on content included in the request. Here, the host platform may compare the device fingerprint to the list of “banned” device fingerprints which may be stored in the graph database. If the newly created device fingerprint matches an existing device fingerprint of a banned user device, the host platform may automatically ban the new user account. In other words, even though the new user account has yet to transact on the online marketplace, the new user account can be banned from the site / marketplace based on the device fingerprint of the device being used by the user account.

Furthermore, the banned user account may be used to identify other user devices that should also be banned. For example, another device that is being used by the now banned user account may also be proactively banned (e.g., by banning a device fingerprints of the other device.) Likewise, any additional user accounts associated with / that use the other device may also be proactively banned. This process may be iteratively performed until no new user accounts or devices can be found. Also, the number of “hops” between the real-time banned user and the proactively banned user accounts may be limited. For example, a parent or a sibling of the banned user may be banned, but a cousin or a grandparent may not be banned, etc.

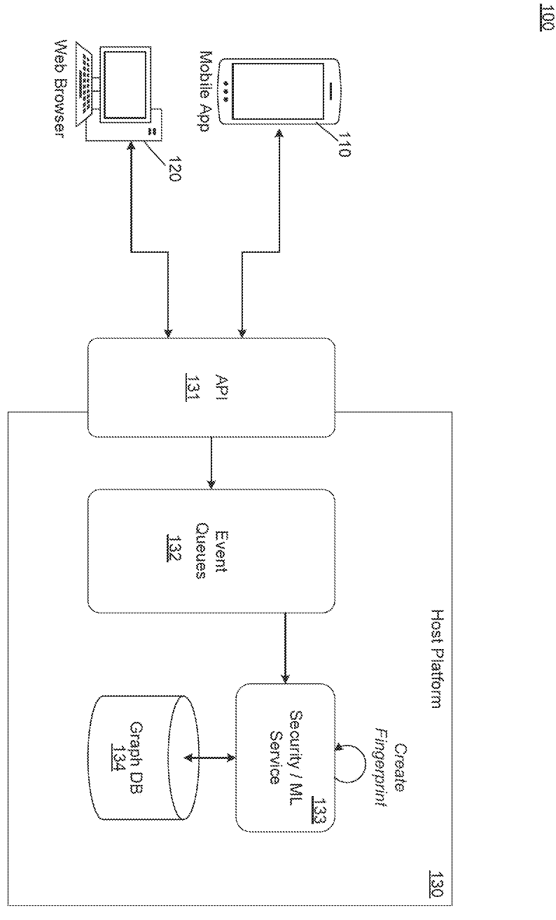

FIG. 1 illustrates a computing environment 100 of an online marketplace for fraud detection in accordance with an example embodiment. Referring to FIG. 1, the computing environment 100 includes a host platform 130 which hosts the online marketplace. As an example, the host platform 130 may be a cloud platform, a web server, a database, a combination of devices, and the like. The host platform 130 may manage various user accounts that interact with each other on the online marketplace. A user may access the online marketplace by connecting to the host platform 130 via a user device such as a user device 110 (e.g., a mobile device, etc.) or a user device 120 (e.g., a personal computer, etc.) These are just examples of the types of devices that can be used. It should be appreciated that both mobile applications / devices and browser-based applications and devices may connect to the online marketplace and transact.

Although the example embodiments refer to an online marketplace, it should be appreciated that the example embodiments can be used on any website, PWA, mobile application, or the like, in which fraud occurs. As an example, the real-time banning process described herein may be applied to vacation rental sites/apps, employment sites/apps, video gaming platforms, and the like.

Each of the user devices 110 and 120 may experience different user sessions. For example, the user device 110 may correspond to a seller and the user device 120 may correspond to a buyer, but embodiments are not limited thereto. The buyer may purchase an item for sale posted by the seller. Each session may result in different pages of the website or mobile application being loaded.

To access the host platform 130 (and the online marketplace), the user devices 110 and 120 may send requests to an application programming interface (API) 131 of the host platform 130. The API 131 may ensure / verify that the request includes the clickstream data of the user and also device attributes capable of creating a device fingerprint. For example, when user device 110 sends a request to transact on the online marketplace, the API 131 ensures / verifies that the request sent from the user device 110 includes both the clickstream data (used for detecting fraud using machine learning, etc.) and device fingerprint attributes (e.g., screen size, resolution, plug-in data, time zone, language, etc.) If not, the API 131 may decline the request.

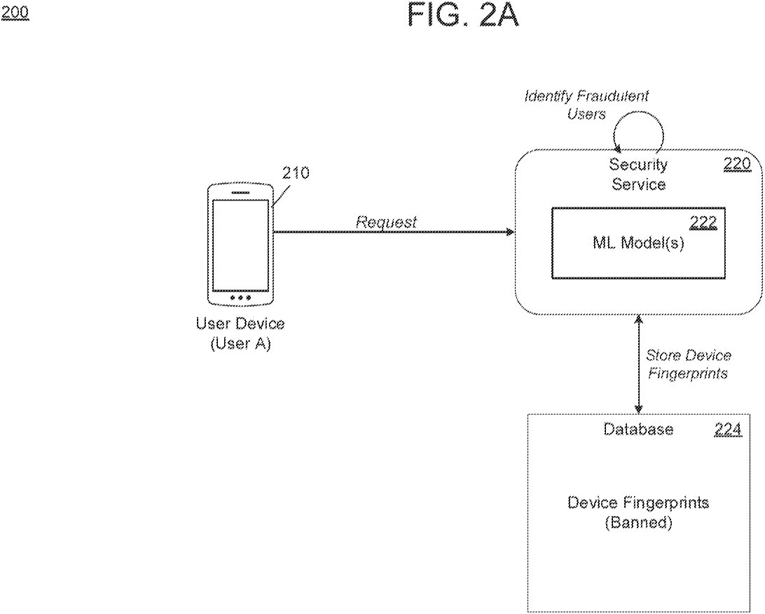

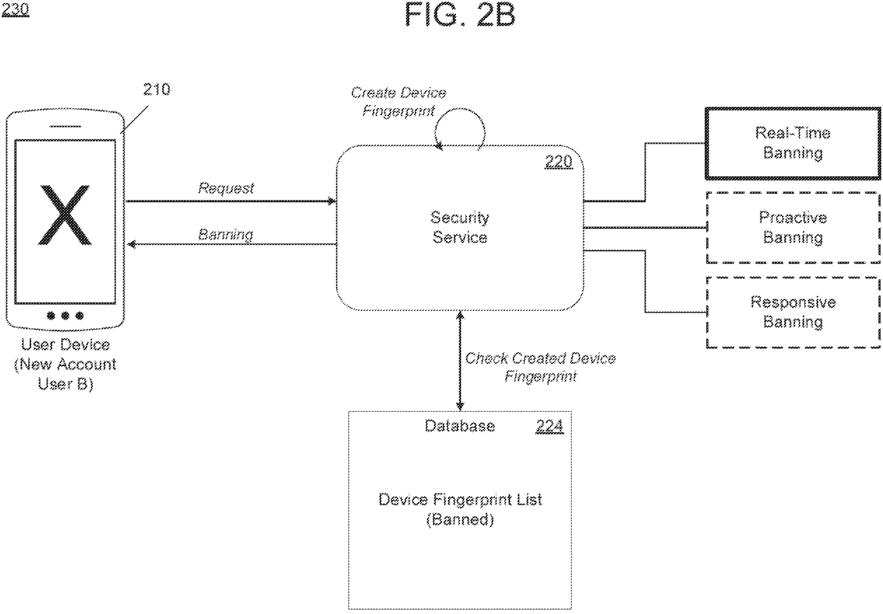

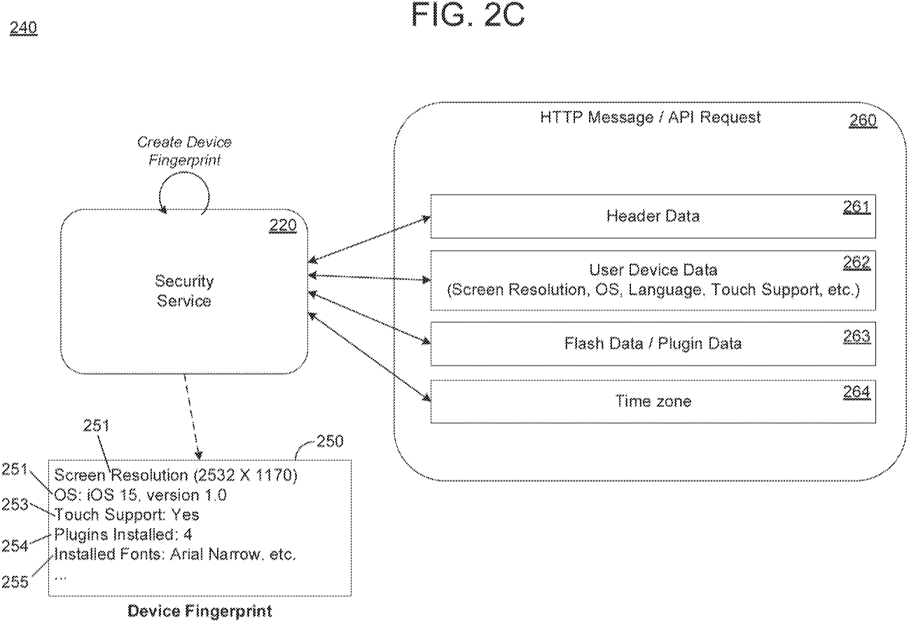

Initially, the buyer and the seller are permitted to use the online marketplace of the host platform 130 without any restrictions. However, as further described in the example of FIG. 2B, the host platform 130 may include a security service 133 that monitors transaction content and clickstream data of the user devices 110 and 120 to determine whether the user accounts associated therewith are fraudulent. For example, requests from the user device 110 and the user device 120 may be stored in an event queue 132 and analyzed by the security service 133 in the order they are received. Initially, the security service 133 may attempt to identify the user account and/or the device fingerprint of the user device 110 within a list of banned user accounts and/or device fingerprints stored in the graph database 134. If not, the security service 133 may analyze the transaction data of the request (as well as other requests from the user device 110) to determine whether the user account is attempting to conduct fraud of some kind within the online marketplace.

As an example, the security service 133 may have installed therein or may otherwise access a remote service that performs machine learning based on the transaction data from the user devices 110 and 120. The machine learning may include executing a plurality of machine learning models to identify fraudulent content. When the security service 133 identifies fraudulent content (e.g., fraudulent content posted by user device 110) via one or more of the machine learning models, the user account and the user device 110 associated with the fraudulent content can be banned and identifiers of both may be stored in a graph database 134. Here, the security service 133 may create a device fingerprint of the user device 110 based on the device attributes included in the request from the user device 110, and store the device fingerprint in the graph database 134 with an identifier that the device fingerprint is fraudulent/ banned.

Now, when subsequent users attempt to access the online marketplace, the user devices send a request to the host platform 130 via the API 131. Here, the request is stored in the event queue 132 and analyzed by the security service 133. Initially, the security service 133 may create a device fingerprint of the request, and check / compare the device fingerprint to other “banned” device fingerprints stored in the graph DB 134. If a match is found, the user account / user device are banned.

For example, if a user of the user device 110 is found to have been using their account for fraud, the security service 133 may store a device fingerprint of the user device 110 in the graph DB 134. Likewise, the security service 133 may store an identifier of the user account in the graph DB 134. If the user were to delete their existing account and start a new account, the user device 110 would send a request to transact based on the new user account. In this case, the request would also include the device fingerprint data. Here, the security service 133 will create a device fingerprint of the user device 110 associated with the new user account and match the device fingerprint of the new account to a device fingerprint of the old user account which was deleted. Thus, the security service 133 can detect that the new account is a fraudulent account and ban the new account even before the new user account has had a chance to transact on the online marketplace.

Interest in selling used / second-hand goods through online platforms is growing. This also attracts fraudsters to the online platforms as they get a lot of contact points to commit frauds. The severity and mode of these undesirable activities vary across buyers and sellers. For example, fraudulent sellers/buyers may carry out illegal transactions on the online platforms. These undesirable activities degrade the online platform’s reputation and induce resistance among normal users. This may cause low retention and poor enrolment of consumers with the used goods platforms.

In order to detect fraudulent sellers, a systematic approach consisting of statistical models and machine learning models which analyze transaction content can be used but it will not solve the problem fully. These solutions are “reactive” to the problem, and not “proactive”. In other words, for a user account to be banned, that user account must commit fraud on the platform. Otherwise, there is no way to connect the user account to other user accounts that have previously been used by the same user to commit fraud. As a result, most fraudsters will simply create multiple accounts. When one account is compromised, the fraudster can move to another / new user account and continue fraud. The collection and processing of all of the user-data to identify fraudsters takes hours or even days, which is sufficient time for fraudulent activities to be conducted on online platforms. Once a fraudster is caught committing fraud via a first user account, they simply switch to a second / new user account to do the fraudulent activities there as well. The anonymity of the online world makes it easy.

In the example embodiments, a solution is provided that can detect a fraudulent user with a heightened level of confidence even before that user transacts on the host platform. The system tracks both users and their devices through device fingerprints. Furthermore, the system can prevent a banned user from creating and using a new account on the same device.

In the example embodiments, device fingerprint banning (DFP) an account can take place instantly, in real-time, without reliance on historical transaction data of a user. Thus, action on a new user account can be taken immediately before the new user account has a chance to transact. Furthermore, proactive banning can also be performed to identify one-off users and devices (or two-off, etc.). The proactive rules used in the proactive banning may not require any preprocessing of loading and transacting data warehouses, so they are fast and reliable. Usage of a Graph DB provides for more linkages between fraudulent users and fraudulent devices (device fingerprints).

FIG. 2A illustrates a process 200 of identifying a fraudulent user account based on machine learning in accordance with example embodiments. Referring to FIG. 2A, a security service 220 (e.g., hosted by a host platform of an online / mobile application, etc.) may have one or more machine learning models 222 installed therein or accessible via an external service (not shown) that the security service 220 can access and use to identify fraudulent users from clickstream data and transaction data submitted to the host platform. For example, the machine learning model(s) 222 may be trained to identify fraudulent user activity based on user behavior identified from clickstream data and/or transaction content posted to the host platform. The machine learning model(s) 222 may be trained using historical clickstream data and transaction data of previously-labeled fraudulent content / user accounts to learn to identify patterns of fraudulent user behavior.

When a user device 210 submits a request to the host platform (e.g., a request to transact on the online marketplace, application, etc.), the security service 220 may identify the request and extract clickstream data including sites, ads, buttons, time spent, etc. that are clicked on by the user, as well as transaction content, messages, ads, posts, etc., submitted to the host platform (e.g., the online marketplace, etc.) The machine learning model(s) 222 may be executed on such input data to identify whether the input data correlates to a pattern of behavior of a fraudulent user. If so, the security service may ban the user account associated with the user device 210 that submitted the request. In addition, the security service 220 may also create a device fingerprint of the user device 210 and ban the device fingerprint from transacting on the online marketplace as well. The device fingerprint may be stored in a database 224 (such as a graph DB) which includes a list of banned device fingerprints and user accounts.

FIG. 2B illustrates a process 230 of auto-banning a new user account based on device fingerprinting in accordance with example embodiments. Referring to FIG. 2B, the user of the user device 210 has deleted the user account (User A) in FIG. 2A, and started a new user account in the process 230 of FIG. 2B. Here, the new user account has not been used to transact on the online platform, and in fact, is not listed as a fraudulent user. When the user device 210 submits a request to transact on the host platform, the security service 220 may receive the request, and determine whether the new user account is fraudulent.

For example, the security service 220 may compare the user account to previously-banned user accounts. As another option, the security service 220 may create a device fingerprint of the user device 210 associated with the new user account, and determine whether the device fingerprint has previously been banned. In this case, the security service 220 would not find the new user account listed under the banned user accounts, since the user account has not been used. However, the security service 220 will find that the device fingerprint of the user device 210 associated with the new user account is already banned by the process 200 shown in FIG. 2A. Thus, the security service 220 can automatically ban the new user account. In addition, the security service 220 may modify the database 224 to store / update the device fingerprint of the user device 210 to include a pointer to the new user account in the database 224 as further explained below with respect to FIG. 2C.

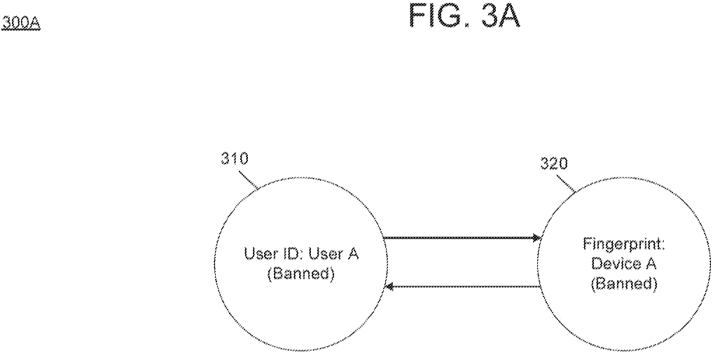

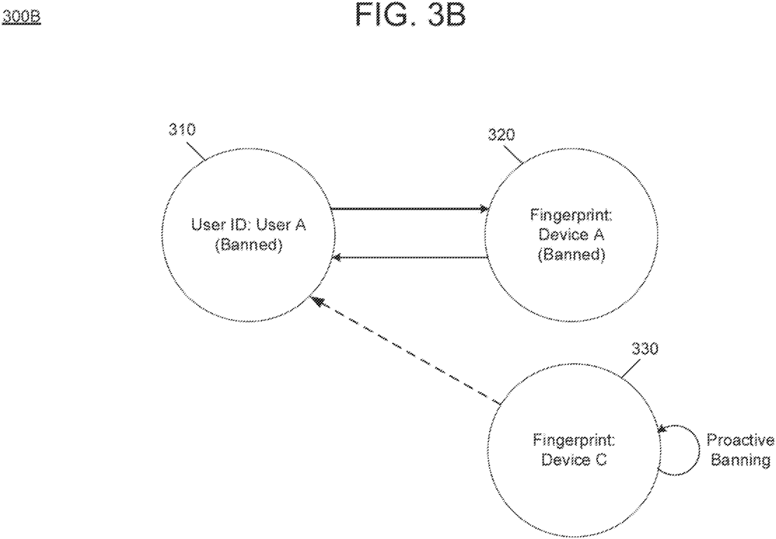

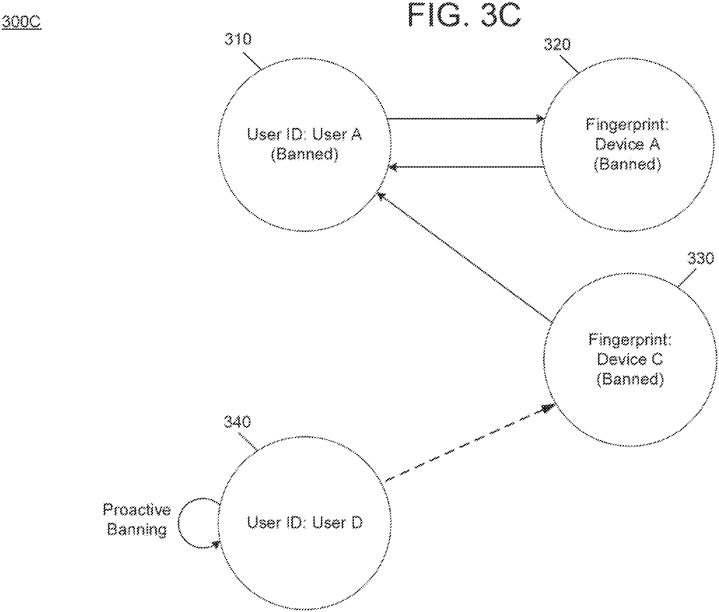

The banning may take different forms. For example, real-time banning may be performed when the device fingerprint identifies a fraudulent device being used again. As another example, proactive banning may be performed as further described in the examples of FIGS. 3A-3C. Proactive banning may be based on one-off users / devices that are related to the banned device. Furthermore, responsive banning may be performed based on transaction content / clickstream data.

FIG. 2C illustrates a process 240 of creating a device fingerprint 250 including a plurality of device attributes 251, 252, 253, 254, and 255, in accordance with an example embodiment. Referring to FIG. 2C, the security service 220 may extract user-device details from a request message 260 submitted by the user device 210. As an example, the request message 260 may include a HTTP request (POST, GET, PUT, etc.), an API call, and the like. In some embodiments, it may include both an HTTP request and an API call. The request message 260 includes various attributes 261, 262, 263, and 264 which can be extracted and used for device fingerprinting. This is not an exhaustive list of attributes that can be used for device fingerprinting. Furthermore, not all of these attributes need to be used. In fact, none of these attributes could be used but different attributes could be used.

In this case, the security service 220 is executing on the server-side. The security service may include a policy that specifies which data attributes are to be extracted from the request message 260. The policy may specify a predefined list of attributes. The API of the host platform (e.g., API 131 shown in FIG. 1, etc.) may prevent any message from being delivered that does not include the data attributes specified by the policy. In this example, the API may verify that the request message 260 includes the data attributes 251, 252, 253, 254, and 255 which are then used to construct the device fingerprint 250. Here, values corresponding to the data attributes 251-255 may be extracted and stored in a data record such as a graph database. The record may be used for subsequent comparison when new device fingerprints are generated.

Device fingerprinting (also referred to as canvas fingerprinting, browser fingerprinting, machine fingerprinting, etc.) is a process used to identify a device (or browser) based on its specific and unique configuration. Unlike web cookies that are stored client side (i.e. on a user’s device), device fingerprints are stored server-side.

The security service 220 may receive a vast amount of data, sent every time a web request is sent to the host platform. The security service 220 can then use this data that is already inherently stored in the web requests to create a device fingerprint including header data (e.g., HTTP header), screen size, screen resolution, number of plugins installed, type of plugins installed, time zone settings, language settings, etc. Device-fingerprinting services create fingerprints based on a combination of multiple data points. The example embodiments may not use an IP address of a device for the purposes of device fingerprinting because an IP address can change easily and therefore IP addresses are not a very effective way of identifying a user account or a user device. In the present application, non-IP address attributes may be used to create the device fingerprint including, but not limited to, the following attributes.
HTTP request headers
User agent string
Installed plugins
Client time zone
Information about the client device: screen size, screen resolution, touch support, operating system and language
Flash data provided by a Flash plugin
List of installed fonts
Silverlight data
List of mime-types
Timestamp

As people become more connected to the online world and carry out an increasing number of actions online, they are more and more inclined to use multiple devices to accomplish their tasks. And this makes it harder for brands to connect personally with their target audiences. This problem is only augmented because normal means of online tracking are more challenging today. Cookies, which have been the mainstay of digital advertising for years, have become more and more untenable in today’s privacy-sensitive environment. For example, cookies do not offer a reliable way to track mobile usage, cookies can be easily disabled or deleted by the consumer, cookies make ads and ad campaigns more easily recognizable to ad blockers, effectively killing any chance an advertiser may have of connecting with a potential customer, and the like.

Meanwhile, device fingerprinting offers a backup method of tracking when cookies can’t get the job done. Calculating a device fingerprint may begin when a user visits a website or mobile application. The security service 220 may implement a device fingerprint tracker, which may include a piece of JavaScript, that collects all relevant device information such as the attributes 251-255 from the request message 260.

The more information that is obtained, the easier it is to apply statistics and narrow it down to a single device / person. Furthermore, the security service 220 may assign a unique identifier to the device fingerprint, for example, a hash of the attributes 251-255 included in the device fingerprint, as one example. The advantage here for companies using device fingerprinting is that it’s almost impossible to block the creation of device fingerprints because the API of the example embodiments requires the attributes to be included in the request message 260, otherwise the message will not be delivered. Device fingerprints can also be enriched by linking the “user account” to other device fingerprints (i.e. devices).

FIGS. 3A-3C illustrate a proactive banning process based on a graph database in accordance with example embodiments. As a user account is auto-banned from the site / platform, the security service may also ban other user accounts and devices that are related (e.g., a one off, a two off, etc.) of the user account. For example, users that also use the same device as the banned user may be banned as well. As another example, other devices used by the banned user may also be banned, even if it’s not the user’s primary device and the device belongs to someone else.

FIG. 3A illustrates a process 300A of storing information about a banned user account within a graph database, such as the graph database 134 shown in FIG. 1. Referring to FIG. 3A, the security service may store a first node 310 corresponding to the user account identifier and a second node 320 corresponding to the device fingerprint. The “nodes” may be individually linked to one another. In this example, the first node 310 can include a link or pointer to the second node 320. For example, an identifier of the second node 320 may be stored in the first node 310. The identifier may uniquely identifier the second node 320, for example, based on a hash of the device fingerprint data, etc. Thus, the first node 310 can be mapped to the second node 320. Likewise, the second node 320 may store an identifier of the first node 310 such as a hash value of the user account identifier or some other unique identifier of the first node 310 created by the security service. Thus, the second node 320 can also be mapped to the first node 310.

FIG. 3B illustrates a process 300B of proactively banning a second user device that has been previously used by the user account banned in FIG. 3A. Here, the security service may identify any other devices in the graph database that also have a pointer to the first node 310 representing the user account that was banned in FIG. 3A. In this example, a device that is represented by a third node 330 in the graph database that represents a device fingerprint of a second device (Device C). Here, the third node 330 includes a pointer to the first node 310 indicating that the user account represented by the first node 310 used the second device corresponding to the third node 330. For example, the third node 330 may include an identifier of the node 310 stored therein.

Accordingly, the security service may identify the third node 330 based on the pointer to the first node 310, and also ban the device corresponding to the third node 330 on the online resource. Furthermore, the graph database can be updated to reflect that the third node 330 represents a device fingerprint of a device that has been banned. This process may be repeated to an additional hop of users that are directly adjacent to the third node 330, and so on. A limit may be imposed on the number of hops which can be used for banning, for example, two hops, or the like.

FIG. 3C illustrates a process 300C of proactively banning a second user account that has previously used the user device that is banned in the process of FIG. 3A. Referring to FIG. 3C, the graph database also includes a fourth node 340 that represents a second user account (User D). Here, the second user account also used the first user device corresponding to the second node 320 in FIG. 3A. Thus, the graph database will have established a link between the fourth node 340 of the second user and the second node 320 of the first device fingerprint. Likewise, this same link can be used to ban the second user account corresponding to the fourth node 340, and so on. Each node in the graph database essentially acts as a seed that can be used to identify other nodes (device or user accounts) that should be proactively banned.

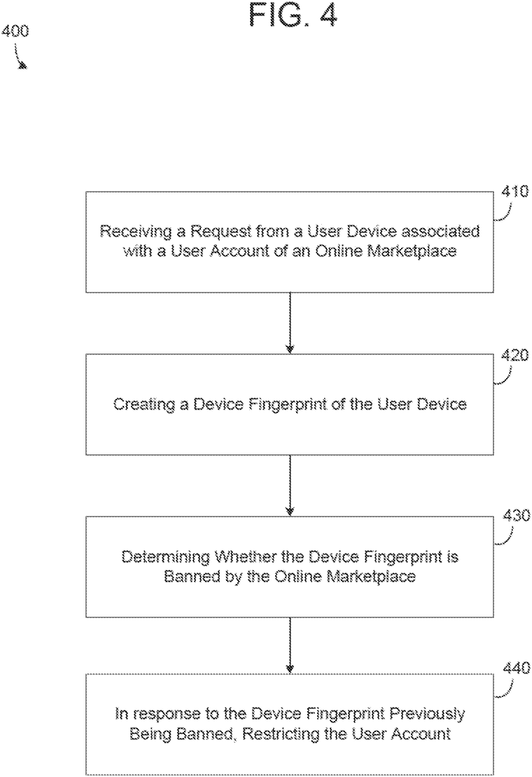

FIG. 4 illustrates a method 400 of automatically banning a new user account in accordance with example embodiments. For example, the method 400 may be performed by a web server, a host platform, a cloud platform, a database, and/or the like. In some embodiments, the method may be performed by a host platform of a mobile application and/or a web-based application such as a progressive web application (PWA), however embodiments are not limited thereto.

Referring to FIG. 4, in 410, the method may include receiving, by a host platform of an online resource, a request from a user device associated with a user account of an online marketplace. The online resource may be a mobile application, a website, a web application such as a PWA, and the like. As another example, the request may be a HTTP request sent from the user device (e.g., a front-end of a mobile application, web browser, etc.). As another example, the request may be an API call, or the like. The request may include a number of different device attributes which can be used for device fingerprinting including screen size, resolution, operating system, browser plugins, time zone, language settings, and the like. Multiple data attributes may be combined to create a unique device fingerprint. The attributes may be non-IP address attributes because an IP address is not a static identifier and can easily be changed by the user device (e.g., by simply restarting the user device, etc.)

In 420, the method may include creating, by the host platform, a device fingerprint of the user device based on a plurality of device attributes included in the request. Here, the system may create the device fingerprint using the combination of data attributes of the device which are obtained or otherwise extracted from the request. In 430, the method may include determining, by the host platform, whether the device fingerprint was previously banned based on previously banned device fingerprints of the online resource. In response to a determination that the device fingerprint has been banned previously, in 440, the method may include automatically restricting, by the host platform, an ability of the user account with the online resource.

In some embodiments, the creating may include creating the device fingerprint based on two or more of a screen size of the user device, plugins installed within a browser of the user device, an operating system of the user device, a language setting of the user device, and a time zone setting of the user device, which are obtained from the request. In some embodiments, the method may further include executing a machine learning model based on historical user transaction data of the online marketplace, identifying a plurality of fraudulent users based on the execution of the machine learning model, and storing a plurality of device fingerprints of the plurality of fraudulent users, respectively, in a graph database.

In some embodiments, the determining may include comparing the device fingerprint of the user device to the plurality of device fingerprints (e.g., which have been labelled as banned, etc.) of the plurality of users stored in the graph database. In some embodiments, the receiving may include receiving the request from a new user account that has yet to transact on the online marketplace. In some embodiments, the method may further include queuing the request via an event queue of the host platform and creating the device fingerprint when the request reaches an end of the queue.

In some embodiments, the automatically restricting may include automatically banning the user account from transacting on the online marketplace and mapping an identifier of the user account to an identifier of the device fingerprint in a graph database. In some embodiments, the method may further include identifying another user account that has used the user device based on the device fingerprint, proactively banning the other user account, and mapping an identifier of the other user account to the device fingerprint in the graph database.

The above embodiments may be implemented in hardware, in a computer program executed by a processor, in firmware, or in a combination of the above. A computer program may be embodied on a computer readable medium, such as a storage medium or storage device. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

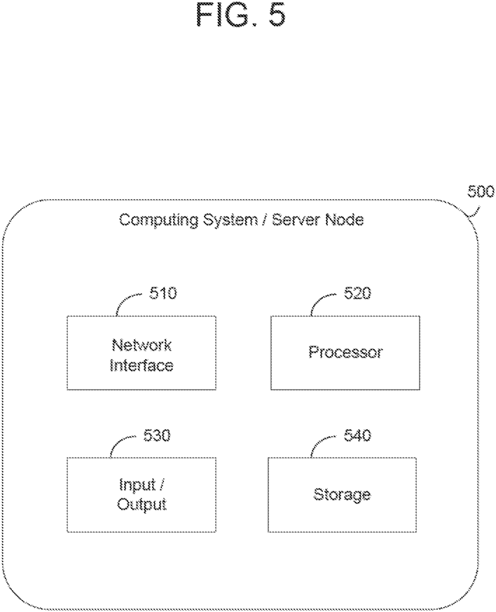

A storage medium may be coupled to the processor such that the processor may read information from, and write information to, the storage medium. In an alternative, the storage medium may be integral to the processor. The processor and the storage medium may reside in an application specific integrated circuit (“ASIC”). In an alternative, the processor and the storage medium may reside as discrete components. For example, FIG. 5 illustrates an example computer system 500 which may represent or be integrated in any of the above-described components, etc. For example, the computer system 500 may represent any of the user device 110, the user device 120, and the host platform 130 shown in FIG. 1. FIG. 5 is not intended to suggest any limitation as to the scope of use or functionality of embodiments of the application described herein. The computing system 500 is capable of being implemented and/or performing any of the functionality set forth hereinabove.

The computing system 500 may include a computer system/server, which is operational with numerous other general purpose or special purpose computing system environments or configurations. Examples of well-known computing systems, environments, and/or configurations that may be suitable for use as computing system 500 include, but are not limited to, personal computer systems, cloud platforms, server computer systems, thin clients, thick clients, hand-held or laptop devices, tablets, smart phones, databases, multiprocessor systems, microprocessor-based systems, set top boxes, programmable consumer electronics, network PCs, minicomputer systems, mainframe computer systems, distributed cloud computing environments, and the like, which may include any of the above systems or devices, and the like. According to various embodiments described herein, the computing system 500 may be a web server.

The computing system 500 may be described in the general context of computer system-executable instructions, such as program modules, being executed by a computer system. Generally, program modules may include routines, programs, objects, components, logic, data structures, and so on that perform particular tasks or implement particular abstract data types. The computing system 500 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, the computing system 500 is shown in the form of a general-purpose computing device. The components of computing system 500 may include, but are not limited to, a network interface 510, one or more processors or processing units 520, an input / output 530 which may include a port, an interface, etc., or other hardware, for inputting and/or outputting a data signal from / to another device such as a display, a printer, etc., and a storage device 540 which may include a system memory, or the like. Although not shown, the computing system 500 may also include a system bus that couples various system components including system memory to the processor 520. In some embodiments, the input / output 530 may also include a network interface.

The storage 540 may include a variety of computer system readable media. Such media may be any available media that is accessible by computer system/server, and it may include both volatile and non-volatile media, removable and non-removable media. System memory, in one embodiment, implements the flow diagrams of the other figures. The system memory can include computer system readable media in the form of volatile memory, such as random-access memory (RAM) and/or cache memory. As another example, storage device 540 can read and write to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, storage device 540 may include at least one program product having a set (e.g., at least one) of program modules that are configured to carry out the functions of various embodiments of the application.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Although not shown, the computing system 500 may also communicate with one or more external devices such as a keyboard, a pointing device, a display, etc.; one or more devices that enable a user to interact with computer system/server; and/or any devices (e.g., network card, modem, etc.) that enable computing system 500 to communicate with one or more other computing devices. Such communication can occur via I/O interfaces. Still yet, computing system 500 can communicate with one or more networks such as a local area network (LAN), a general wide area network (WAN), and/or a public network (e.g., the Internet) via network interface 510. As depicted, network interface 510 may also include a network adapter that communicates with the other components of computing system 500 via a bus. Although not shown, other hardware and/or software components could be used in conjunction with the computing system 500. Examples include, but are not limited to: microcode, device drivers, redundant processing units, external disk drive arrays, RAID systems, tape drives, and data archival storage systems, etc.

It will be readily understood that descriptions and examples herein, as generally described and illustrated in the figures, may be arranged and designed in a wide variety of different configurations. Thus, the detailed description of the embodiments is not intended to limit the scope of the application as claimed but is merely representative of selected embodiments of the application. One of ordinary skill in the art will readily understand that the above may be practiced with steps in a different order, and/or with hardware elements in configurations that are different than those which are disclosed. Therefore, although the application has been described based upon some preferred embodiments, it would be apparent to those of skill in the art that certain modifications, variations, and alternative constructions would be apparent.

What is claimed is:

1. A computing system comprising:
a network interface configured to receive a request from a user device associated with a user account of an online resource; and
a processor configured to
create a device fingerprint of the user device based on a plurality of device attributes included in the request,
determine whether the device fingerprint matches a previously banned device fingerprint stored in a database by the online resource; and
in response to a determination that the device fingerprint matches a previously banned device fingerprint, automatically restrict an ability of the user account with the online resource.

2. The computing system of claim 1, wherein the processor is configured to create the device fingerprint based on two or more of a screen size of the user device, plugins installed within a browser of the user device, an operating system of the user device, a language setting of the user device, and a time zone setting of the user device, which are obtained from the request.

3. The computing system of claim 1, wherein the processor is further configured to execute machine learning models based on historical user data of the online resource, identify a plurality of fraudulent users based on the execution of the machine learning models, and store a plurality of device fingerprints of the plurality of fraudulent users, respectively, in a graph database.

4. The computing system of claim 3, wherein the processor is configured to compare the device fingerprint of the user device to the plurality of device fingerprints of the plurality of users stored in the graph database.

5. The computing system of claim 1, wherein the network interface is configured to receive the request from a new user account that has yet to post content to the online resource.

6. The computing system of claim 1, wherein the processor is further configured to queue the request via an event queue of the host platform and create the device fingerprint when the request reaches an end of the event queue.

7. The computing system of claim 1, wherein the processor is configured to automatically ban the user account from the online resource and map an identifier of the user account to an identifier of the device fingerprint in a graph database.

8. The computing system of claim 7, wherein the processor is further configured to identify another user account that has used the user device based on the device fingerprint, proactively ban the other user account from the online resource, and map an identifier of the other user account to the device fingerprint in the graph database.

9. A method comprising:
receiving, by a host platform of an online resource, a request from a user device associated with a user account of the online resource;
creating, by the host platform, a device fingerprint of the user device based on a plurality of device attributes included in the request;
determining, by the host platform, whether the device fingerprint matches a previously banned device fingerprint stored in a database by the online resource; and
in response to a determination that the device fingerprint matches a previously banned device fingerprint, automatically restricting, by the host platform, an ability of the user account with the online resource.

10. The method of claim 9, wherein the creating comprises creating the device fingerprint based on two or more of a screen size of the user device, plugins installed within a browser of the user device, an operating system of the user device, a language setting of the user device, and a time zone setting of the user device, which are obtained from the request.

11. The method of claim 9, wherein the method further comprises executing machine learning models based on historical user data of the online resource, identifying a plurality of fraudulent users based on the execution of the machine learning models, and storing a plurality of device fingerprints of the plurality of fraudulent users, respectively, in a graph database.

12. The method of claim 11, wherein the determining comprises comparing the device fingerprint of the user device to the plurality of device fingerprints of the plurality of users stored in the graph database.

13. The method of claim 9, wherein the receiving comprises receiving the request from a new user account that has yet to post content to the online resource.

14. The method of claim 9, wherein the method further comprises queuing the request via an event queue of the host platform and creating the device fingerprint when the request reaches an end of the event queue.

15. The method of claim 9, wherein the automatically restricting comprises automatically banning the user account from the online resource and mapping an identifier of the user account to an identifier of the device fingerprint in a graph database.

16. The method of claim 15, wherein the method further comprises identifying another user account that has used the user device based on the device fingerprint, proactively banning the other user account from the online resource, and mapping an identifier of the other user account to the device fingerprint in the graph database.

17. A non-transitory computer-readable medium comprising instructions which when executed by a processor cause a computer to perform a method comprising:
receiving, by a host platform of an online resource, a request from a user device associated with a user account of the online resource;
creating, by the host platform, a device fingerprint of the user device based on a plurality of device attributes included in the request;
determining, by the host platform, whether the device fingerprint matches a previously banned device fingerprint stored in a database by the online resource; and
in response to a determination that the device fingerprint matches a previously banned device fingerprint, automatically restricting, by the host platform, an ability of the user account with the online resource.

18. The non-transitory computer-readable medium of claim 17, wherein the creating comprises creating the device fingerprint based on two or more of a screen size of the user device, plugins installed within a browser of the user device, an operating system of the user device, a language setting of the user device, and a time zone setting of the user device, which are obtained from the request.

19. The non-transitory computer-readable medium of claim 17, wherein the method further comprises executing machine learning models based on historical data of the online resource, identifying a plurality of fraudulent users based on the machine learning model, and storing a plurality of device fingerprints of the plurality of users, respectively, in a graph database.

20. The non-transitory computer-readable medium of claim 19, wherein the determining comprises comparing the device fingerprint of the user device to the plurality of device fingerprints of the plurality of users stored in the graph database.
